(19) United States
(12) Patent Application Publication
(10) Pub. No.: US 2008/0011547 A1
(43) Pub. Date: Jan. 17, 2008

(54) Ladder carrying device

(76) Inventor: Louis T. Bonitto, Brockton, MA (US)

Correspondence Address: HOLLAND & KNIGHT LLP, 10 ST. JAMES AVENUE, 11th Floor, BOSTON, MA, 02116-3889, US

(21) Appl. No.: 11/487,891

(22) Filed: Jul. 17, 2006

(51) Int. Cl. E06C 5/32

(52) U.S. Cl. 182/129

(57) ABSTRACT

A ladder carrying device includes a shoulder rest having an upper surface and a lower surface, and a ladder clamp extending from the upper surface of the shoulder rest. The ladder clamp is configured to attach the ladder carrying device to a ladder and allow the lower surface of the shoulder rest to contact a user's shoulder.

### FIELD OF INVENTION

The present invention relates to ladder accessories and more specifically to a device for carrying a ladder.

### BACKGROUND

Construction workers and other trade people, such as electricians, plumbers, painters and carpenters, often use a ladder in their daily work. To get a ladder from one location to another location, such construction workers or trade people typically carry the ladder on their shoulder, with their arm threaded through an opening between the steps or rungs of the ladder. This causes either one of the side rails, if the ladder is carried horizontally, or one of the steps, if the ladder is carried vertically, to rest on the user's shoulder.

Often for strength, the side rail or the step of the ladder has a three-sided box or I-beam shape, which has thin edges along the side rail or step. This thin edge, combined with the weight of the ladder, can cause discomfort or pain in the user's shoulder when carried.

### SUMMARY

The present invention provides a removable ladder carrying device that widens the thin edge and distributes the weight of the ladder where the user rests the ladder on his shoulder.

In general, in one aspect, the invention features a ladder carrying device that includes a shoulder rest having an upper surface and a lower surface. A clamping device extends from the upper surface of the shoulder rest and is configured to attach the ladder carrying device to a ladder in a manner that allows the lower surface of the shoulder rest to contact a user's shoulder.

In embodiments, the clamping device includes a first ladder clamp and a second ladder clamp spaced from the first ladder clamp to create a gap between the first ladder clamp and second ladder clamp. The gap is sized to accept a portion of the ladder. The first ladder clamp and second ladder clamp are configured so that at least one of the ladder clamps may move relative to the other when the portion of the ladder is inserted into the gap, thereby attaching the ladder carrying device on the ladder.

In other embodiments, the ladder carrying device may be made of plastic, wood, rubber, fiberglass, or aluminum. In other embodiments, the ladder carrying device is made of acrylonitrile butadiene styrene.

In other embodiments, the clamping device includes a first ladder clamp and a second ladder clamp. The first ladder clamp and the second ladder clamp are spaced apart to create a gap between the first ladder clamp and second ladder clamp. The gap is sized to accept a portion of the ladder. A clamp mechanism is located in the first ladder clamp and configured to hold the ladder carrying device on the ladder. In certain embodiments, the clamp mechanism may be a screw, a spring, a spring loaded pin, a spring loaded pad, or a hook and loop fastener.

In other embodiments, the ladder carrying device also includes a soft pad attached to the lower surface of the shoulder rest.

In still other embodiments, the shoulder rest is angled away from the clamping device. In certain embodiments, the shoulder rest angles away from the clamping device from between approximately 10 degrees and 20 degrees.

In general, in another aspect, the invention features a ladder carrying device including a shoulder rest having an upper surface and a lower surface. A first ladder clamp and a second ladder clamp extend from the upper surface of the shoulder rest. The second ladder clamp is spaced from the first ladder clamp to create a gap between the first ladder clamp and second ladder clamp. The gap is sized to accept a portion of the ladder. The first ladder clamp and second ladder clamp are configured to allow at least one of the ladder clamps to move relative to the other when the portion of the ladder is inserted into the gap, thereby attaching the ladder carrying device on the ladder.

In embodiments, the shoulder rest is angled away from the first ladder clamp and the second ladder clamp. In certain embodiments, the shoulder rest angles away from the first ladder clamp and the second ladder clamp from between approximately 10 degrees and 20 degrees.

In embodiments, the first ladder clamp and the second ladder clamp are integral with the shoulder rest.

In certain embodiments, the ladder carrying device may be made of plastic, wood, rubber, fiberglass, or aluminum. In other embodiments, the ladder carrying device may be made of acrylonitrile butadiene styrene.

In other embodiments, the first ladder clamp and second ladder clamp move relative to each other by at least one of the ladder clamps bending. In still other embodiments, the first ladder clamp and second ladder clamp move relative to each other by at least one of the ladder clamps sliding along the upper surface of the shoulder rest.

In embodiments, the ladder carrying device also includes a soft pad attached to the lower surface of the shoulder rest. In other embodiments, the gap has an upper width of between approximately 0.0625 and 0.50 inches and a lower width greater than the upper width.

The invention can be implemented to realize one or more of the following advantages. The ladder carrying device provides greater comfort for a user when carrying a ladder and reduces the chance of injuries. A “press-on” and “pull-off” feature of the ladder carrying device enables the device to be used on multiple ladders and to be repositioned on a ladder for different users. The “press-on” and “pull-off” feature also allows quick and easy attachment and removal of the device. The small size of the device allows the user to leave the device on the ladder while the ladder is in use.

Other features and advantages of the invention are apparent from the following description, and from the claims.

### BRIEF DESCRIPTION OF THE DRAWINGS

FIG. 1 is an end view of a ladder carrying device according to one embodiment of the invention.

FIG. 2 is perspective view of the ladder carrying device of FIG. 1.

FIG. 3 is an end view of the ladder carrying device of FIG. 1 attached to a ladder resting on a user's shoulder.

FIG. 4 is a perspective view of the ladder carrying device of FIG. 1 attached to a ladder resting on a user's shoulder.

FIG. 5. is an end view of the ladder carrying device according to another embodiment of the invention.

FIG. 6. is an end view of the ladder carrying device according to another embodiment of the invention.

Like reference numbers and designations in the various drawings indicate like elements.

### DETAILED DESCRIPTION

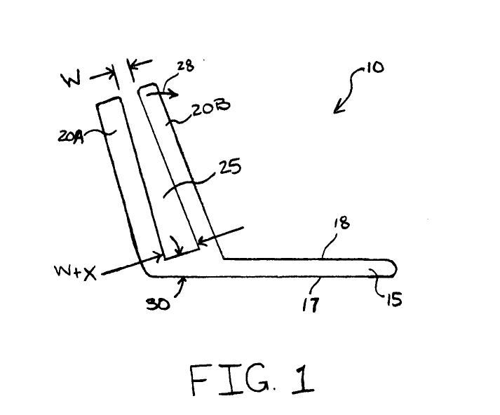

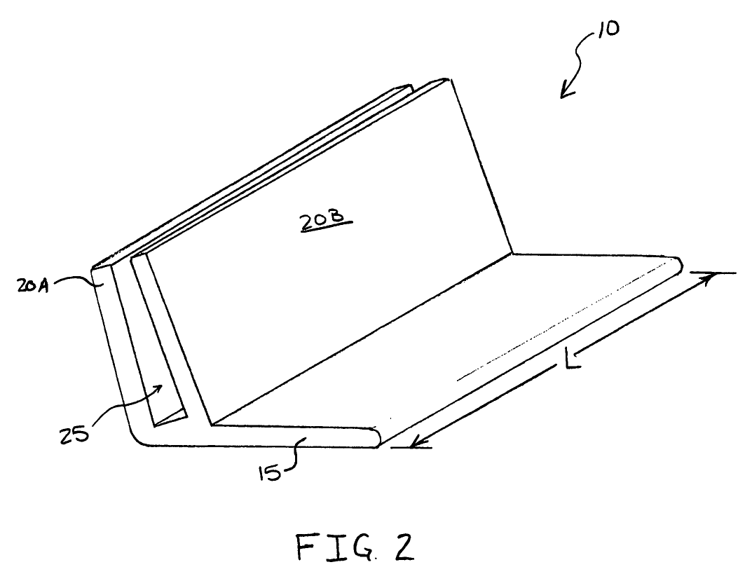

As shown in FIGS. 1 and 2, a ladder carrying device 10 includes a shoulder rest 15 that has a lower surface 17 and an upper surface 18. Extending from the upper surface 18 of the shoulder rest 15 are two ladder clamps 20A, 20B. The ladder clamps 20A, 20B are spaced from each other to provide a gap 25, into which a portion of a ladder can rest, explained fully below.

The ladder clamps 20A, 20B are configured to allow at least one of them to move relative to the other, such as by bending in the direction of arrow 28, and to spring back towards its original shape, similar to a spring-clamp. This bending and spring back may be accomplished by either the materials used for the ladder carrying device 10, the shape of the ladder clamps 20A, 20B, or both the materials and shape. For example, the ladder carrying device 10 may be made of a plastic material, such as acrylonitrile butadiene styrene (“ABS”). ABS provides toughness, wear resistance, good electrical insulating properties, and can be configured to provide a degree of flexibility. Manufacturing the ladder carrying device 10 of ABS also enables molding the ladder carrying device 10.

The gap 25 has an upper width W that expands to a lower width W+X near the upper surface 18 of the shoulder rest 15. The upper width W is sized to enable the ladder clamps 20A, 20B to move away from each other as the ladder carrying device 10 is mounted on a ladder. Thus, the upper width W should be less than the thickness of the portion of the ladder on which it will be mounted (as explained fully below), which causes, for example, one ladder clamp 20B to move in the direction of arrow 28. Lower width W+X should be the same size or larger than the thickness of the portion of the ladder on which it will be mounted to prevent or minimize the ladder clamps 20A, 20B from exerting pressure against the ladder near the upper surface 18 of the shoulder rest 15. Since the ladder clamps 20A, 20B are configured to act like spring clamps, and upper width W will be less than the thickness of the portion of the ladder on which it will be mounted, the ladder clamps 20A, 20B will hold the ladder carrying device 10 on the ladder. In one example, the upper width W is from approximately 0.0625 inches ( 1/16 inch) to 0.50 inches (½ inch), more preferably from 0.10 inches ( 1/10 inches) to 0.1875 inches ( 3/16 inch). In another example, lower width W+X is from approximately 0.10 inches ( 1/10 inches) to 0.5 inches (½ inch), more preferably from 0.1875 inches ( 3/16 inch) to 0.25 inches (¼ inch).

The ladder carrying device 10 is configured to enable the shoulder rest 15 to follow the slope of a user's shoulder to more evenly distribute the pressure from the weight of the ladder. The shoulder rest 15 is angled down from the ladder clamps 20A, 20B to follow the slope of a user's shoulder when carrying a ladder. For example, an angle 30 is formed such that the shoulder rest 15 is not perpendicular to the ladder clamps 20A, 20B. In one example, the angle 30 is from approximately 10 degrees to 20 degrees, more preferably 15 degrees.

The ladder carrying device 10 has a length L that enables the ladder carrying device 10 to fit between two steps of a ladder when attached to a rail of a ladder, or to fit between two rails of a ladder if attached to a step of a ladder. In one example, the length L is from approximately 1 inch to 12 inches, more preferably approximately 10 inches.

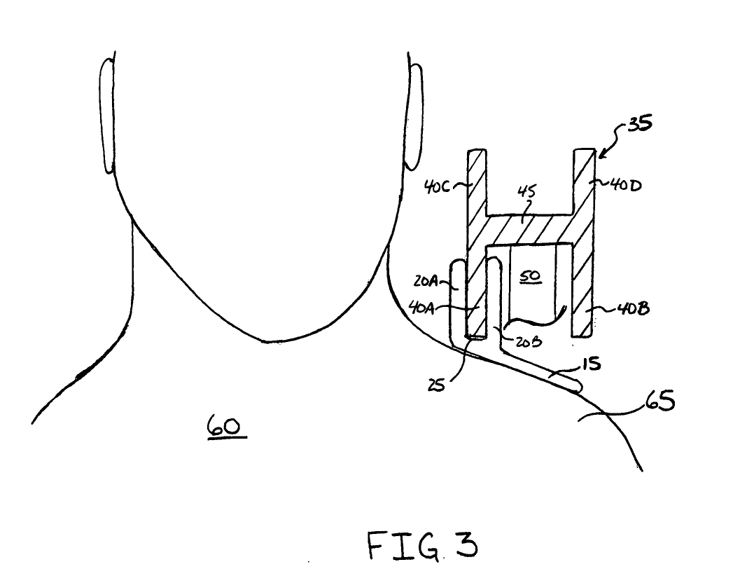

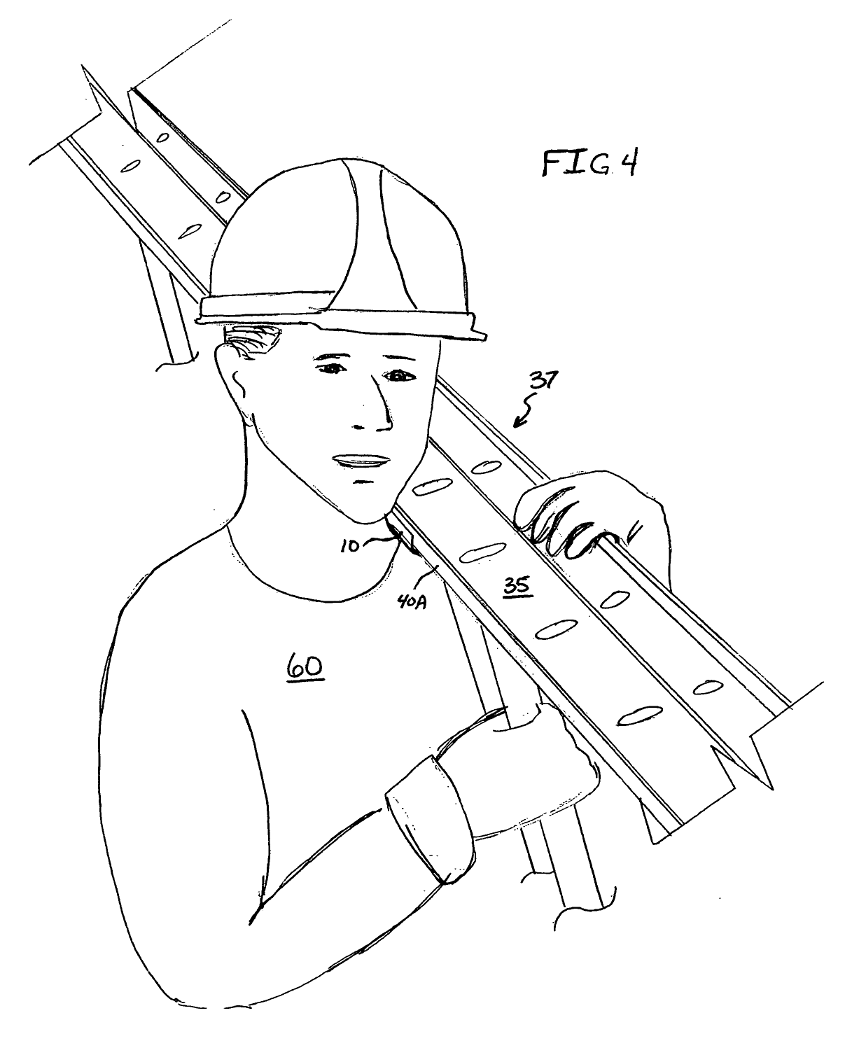

Referring now to FIGS. 3 and 4, the ladder carrying device 10 is shown attached to a rail 35 of a ladder 37 (only a cross section of the rail is shown in FIG. 3). The rail 35 may include flanges 40A, 40B, 40C, 40D that are connected by a web 45. In other embodiments, the rail 35 may be a three-sided box configuration such that the rail 35 includes only flanges 40A and 40B connected by web 45. Steps 50 of the ladder are connected to the rail 35 at the web 45, and to an opposite rail (not shown). The ladder carrying device 10 may be attached to a flange 40A of the ladder. Specifically, the flange 40A is inserted between the ladder clamps 20A, 20B, which separate as the flange 40A is advanced into the gap 25, and the ladder carrying device is pressed onto the rail. The ladder clamps 20A, 20B hold the ladder carrying device 10 to the flange 40A because of their spring clamp-like properties. When a user 60 places his arm through the ladder and rests the rail 35 on his shoulder 65, the shoulder rest 15 generally follows the angle of the user's shoulder 65 to dissipate the weight of the ladder over a larger area. Because the weight is dissipated over a larger area than that provided by the flange 40A alone, there is less chance of user discomfort or pain.

The comfort of the ladder carrying device 10 may be further enhanced by adding a soft pad, such as foam, to the lower surface 17 of the shoulder rest 15. Further, all edges of the ladder carrying device 10 may be eased to prevent any sharp edges from digging into the user's shoulder. Also, easing or angling the edges of the ladder clamps 20A, 20B in the gap 25 at upper width W will enable easier insertion of the flange 40A.

It is to be understood that the foregoing description is intended to illustrate and not to limit the scope of the invention, which is defined by the scope of the appended claims. Other embodiments are within the scope of the following claims. For example, while the ladder carrying device 10 has been described as being made of ABS plastic, other plastics may be used, such as poly vinyl chloride (PVC). Further, other materials may be used to make the ladder carrying device 10, such as wood, rubber, fiberglass or aluminum. While any moldable or machinable material may be used, a non-electrically conductive (i.e., insulating) material is preferred.

Also, while the ladder carrying device 10 has been described as attaching to a rail of a ladder, the ladder carrying device 10 can be configured to attach to a step of a ladder.

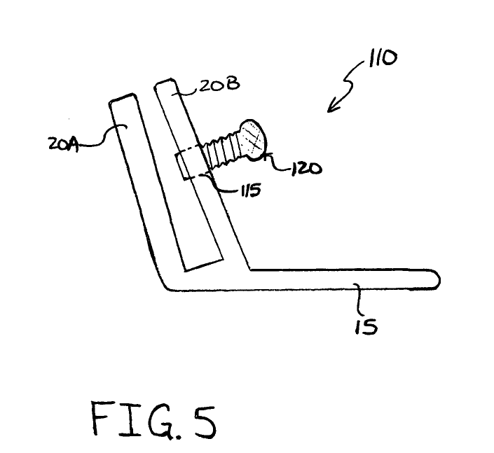

Further still, while the ladder clamps 20A, 20B have been described as being integral with the shoulder rest 15, they may be separate components and attached to the shoulder rest 15. Also, the ladder clamps 20A, 20B may include any type of clamping or mechanical device, such as a screw, a spring, a spring loaded pin, a spring loaded pad or hook and loop fastener (e.g., Velcro®), to attach to the ladder. In such embodiments, the ladder clamps 20A, 20B do not have to be configured to move relative to each other, and upper width W does not need to be less than the thickness of the portion of the ladder on which it will be mounted. In the case of using a hook and loop fastener, one half of the fastener will be attached to a ladder clamp and the other half will be attached to the ladder. In one such example, referring to FIG. 5, a ladder carrying device 110 includes ladder clamps 20A, 20B. One of the ladder clamps 20B has a tapped hole 115 into which a screw 120 is advanced. Here, a thumb screw 120 is shown, but any type of screw would work. When the ladder carrying device 110 is pushed on a flange of a ladder, the screw 120 can be advanced to clamp the ladder carrying device 110 to the ladder.

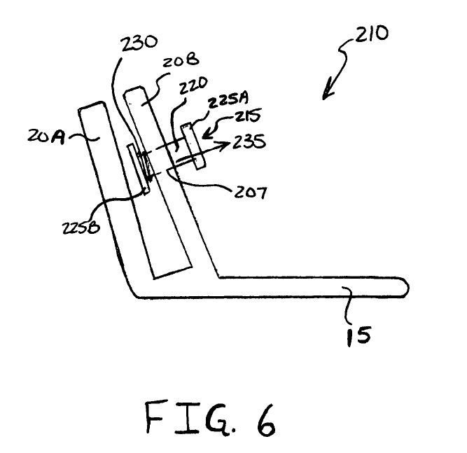

In another example, referring to FIG. 6, a ladder carrying device 210 includes ladder clamps 20A, 20B. One of the ladder clamps 20B includes a hole 207 through which a pin 215 is placed. The pin may include a shaft 220 and two ends 225A, 225B, with the ends 225A, 225B being larger than the shaft 220. A spring 230 is placed around the shaft 220 adjacent to one end 225B of the pin 215. A user would pull on the pin 215 in the direction of the arrow 235, thereby compressing the spring 230 and moving the pin 215 so the ladder carrying device 210 can be pressed on the ladder. Once the ladder carrying device 210 is on the ladder, the user can release the pin 215 and the spring 230 will push the pin 215 against the portion of the ladder between the ladder clamps 20A, 20B.

Also, while the shoulder rest 15 has been described as being flat, the shoulder rest may be configured to generally correspond to the shape of a human shoulder. In such a configuration, either the lower surface 17 of the shoulder rest 15 can be configured to generally correspond to the shape of a human shoulder, or the entire shoulder rest 15 can be so shaped.

What is claimed is:

1. A ladder carrying device comprising:
a shoulder rest having an upper surface and a lower surface; and
a clamping device extending from the upper surface of the shoulder rest configured to attach the ladder carrying device to a ladder and allow the lower surface of the shoulder rest to contact a user's shoulder.

2. The ladder carrying device of claim 1 wherein the clamping device comprises:
a first ladder clamp; and
a second ladder clamp spaced from the first ladder clamp creating a gap between the first ladder clamp and second ladder clamp sized to accept a portion of the ladder, the first ladder clamp and second ladder clamp configured to enable at least one of the ladder clamps to move relative to the other when the portion of the ladder is inserted into the gap thereby attaching the ladder carrying device on the ladder.

3. The ladder carrying device of claim 1 wherein the ladder carrying device is made from a material selected from the group consisting of plastic, wood, rubber, fiberglass, and aluminum.

4. The ladder carrying device of claim 3 wherein the plastic is acrylonitrile butadiene styrene.

5. The ladder carrying device of claim 1 wherein the clamping device comprises:
a first ladder clamp;
a second ladder clamp spaced from the first ladder clamp thereby creating a gap between the first ladder clamp and second ladder clamp sized to accept a portion of the ladder; and
a clamp mechanism located in the first ladder clamp and configured to hold the ladder carrying device on the ladder.

6. The ladder carrying device of claim 5 wherein the clamp mechanism is selected from the group consisting of a screw, a spring, a spring loaded pin, a spring loaded pad, and a hook and loop fastener.

7. The ladder carrying device of claim 1 further comprising a soft pad attached to the lower surface of the shoulder rest.

8. The ladder carrying device of claim 1 wherein the shoulder rest is angled away from the clamping device.

9. The ladder carrying device of claim 8 wherein the shoulder rest angles away from the clamping device from between approximately 10 degrees and 20 degrees.

10. A ladder carrying device comprising:
a shoulder rest having an upper surface and a lower surface;
a first ladder clamp extending from the upper surface; and
a second ladder clamp extending from the upper surface and spaced from the first ladder clamp thereby creating a gap between the first ladder clamp and second ladder clamp sized to accept a portion of the ladder, the first ladder clamp and second ladder clamp configured to enable at least one of the ladder clamps to move relative to the other when the portion of the ladder is inserted into the gap thereby attaching the ladder carrying device on the ladder.

11. The ladder carrying device of claim 10 wherein the shoulder rest is angled away from the first ladder clamp and the second ladder clamp.

12. The ladder carrying device of claim 11 wherein the shoulder rest angles away from the first ladder clamp and the second ladder clamp from between approximately 10 degrees and 20 degrees.

13. The ladder carrying device of claim 10 wherein the first ladder clamp and the second ladder clamp are integral with the shoulder rest.

14. The ladder carrying device of claim 10 wherein the ladder carrying device is made from a material selected from the group consisting of plastic, wood, rubber, fiberglass, and aluminum.

15. The ladder carrying device of claim 14 wherein the plastic is acrylonitrile butadiene styrene.

16. The ladder carrying device of claim 10 wherein the first ladder clamp and second ladder clamp move relative to each other by at least one of the first ladder clamp and second ladder clamp bending.

17. The ladder carrying device of claim 10 wherein the first ladder clamp and second ladder clamp move relative to each other by at least one of the first ladder clamp and second ladder clamp sliding along the upper surface of the shoulder rest.

18. The ladder carrying device of claim 10 further comprising a soft pad attached to the lower surface of the shoulder rest.

19. The ladder carrying device of claim 10 wherein the gap has an upper width of between approximately 0.0625 and 0.50 inches and a lower width greater than the upper width.
